(19) United States
(12) Patent Application Publication
(10) Pub. No.: US 2003/0194546 A1
(43) Pub. Date: Oct. 16, 2003

(54) Foam composite material

(76) Inventor: Brock McCabe, Redondo Beach, FL (US)

Correspondence Address: FISH & RICHARDSON, PC, 4350 LA JOLLA VILLAGE DRIVE, SUITE 500, SAN DIEGO, CA, 92122, US

(21) Appl. No.: 10/121,946

(22) Filed: Apr. 11, 2002

(51) Int. Cl. B32B 3/26; B32B 3/06; B32B 5/14; B32B 3/00

(52) U.S. Cl. 428/304.4; 428/312.8; 428/308.4; 428/306.6

(57) ABSTRACT

A composite foam material formed of combined foam that is combined on a mechanical level to obtain hybrid properties.

### BACKGROUND

Foams may be used for many different purposes including cushioning to avoid damage, and structural reinforcement. However, foam materials have conventional and well-known properties. New chemical formulations of foam, and/or fillers within the foam, are often being formed. A combined foam may chemically mix multiple materials to form a new foam.

### SUMMARY

The present application teaches a mechanically combined foam, formed of foam materials which are combined on a mechanical level. A special kind of composite foam is formed.

According to the present system, various kinds of foams, including polymer foams, metallic foams, and other foams may be mechanically combined to provide materials with different properties.

Hybrid foam properties may be adjusted by changing the materials that are added, and/or by adjusting pore size of those materials. The interaction between the foams may also be increased by surface treating one of the foams, which may be thought of as the primary foam prior to the addition of the secondary foam.

A mechanically combined foam composite material is described. The material mechanically combines multiple different parts.

The foam may be formed by soaking a fully cured open cell foam, the “primary foam”, within a secondary, uncured foam resin. The resin of the secondary foam penetrates into the open cells of the primary foam, to become part of the primary foam. This results in a primary foam with secondary foam within the voids of the primary foam.

Many times, the primary foam will serve as the three-dimensional reinforcement within which the secondary foam will set. For primary foams made out of flexible materials, such as polymers, the primary foam may be compressed while it soaks in the secondary foam. This effectively forms a sponge action that may accelerate resin penetration within the cells of the primary foam. Finally, the primary foam may be removed from the uncured foam resin bath, placed in a heated mold, and molded into a desired form.

The primary foam is a cured open cell foam. Either closed or open cell secondary foams may be formed inside the voids of the primary foam. In this way, the primary, open cell foam serves as the three-dimensional primary scaffolding within which the secondary foam will set. The properties of interest can be derived from either foam or from the synergy between the foams.

A processing variation may operate by cutting the open cell foam into chunks of any size and placing those chunks into a vat of uncured resin. The open cell foam chunks will have a tendency to flow with the foam in direction of the closed cell resin. However, the spacing that is left between the chunks will be filled completely by the resin. This spacing may be varied to vary the resulting characteristics. Since the spacing areas will only closed cell materials, and none of the open cell materials, this may facilitate processing.

Moreover, this resin mixture may be molded more easily than uncut foam. The mixture will take the basic shape of its container, and hence directly in molds shape to the shape of the container. This contrasts with fully cured foam which takes the shape of whenever open cell pre formed foam was originally placed in the resin.

A hybrid foam according to the present system has the ability to combine desirable properties of two different materials, such as two different foams. Specific weaknesses and/or drawbacks of one foam are addressed by combination with another foam that provides the desired characteristics. The resulting hybrid may combine traits of the added foam with the desired properties of the original foam that is being modified. Synergies may also be developed. In addition, the change in range of properties, and also the changes in deformation mechanisms, may allow for additional options in selection of an energy absorbing material.

### EXAMPLE 1

### Sound Absorbing Hybrid Foam

Sound waves reflect off concrete walls, isolating the signal from the region behind the back surface. The mismatching of densities and Young's Moduli between the air and wall often cause this reflection. Using this technique, hybrid foams uniquely fit a sound absorbing model. They have the ability to intimately combine foams of vastly different density and moduli. The total hybrid panel or core shows a repetition of such mismatches within its thickness.

Open Cell/Closed or Open Cell:

### EXAMPLE 2

### Polyurethane/Phenolic Foam Core

Currently, the commercial aerospace industry is looking for new foam cores to be placed in sandwich panels. The foam cores being used now are expensive or flammable. These low-load applications are located within the interior of the plane. Phenolic foam exhibits the lowest flammability and toxicity of any foam. It also has excellent thermal insulation and a low price. But alone, phenolic foam is not tough enough for sandwich panel applications because of its extremely low peel strength. A polyurethane/phenolic hybrid overcomes this by transferring the peel stress from the brittle phenolic portion to the stretchable reticulated polyurethane structure.

In addition, polyurethane/phenolic core panels could be handled much easier within a factory setting than unmodified phenolic foam. Such foams are prone to break and crack.

Another application for this foam is in sandwich panels between hard materials such as aluminum, Kevlar, carbon fiber, carbon fiber, or glass fibers and sandwich panels. This may use a composite foam of polyurethane/phenol. This would be tougher and stronger than conventional phenolic foams. Also, panels of the composite could be handled much easier in the factory setting. Conventional phenolic foam is prone to crack and break when handled roughly. The specific material described herein has the isotropic aspects of conventional foam cores. The aluminum/phenolic foam core couples the strength of the aluminum foam with the isotropic aspects of the conventional foam core.

Other Examples Include:

Vitreus Carbon/Phenolic Foam Core

Carbonized Polyurethane/Phenolic Foam Core

PVC/Phenolic Foam Core

PVC/Polyurethane Foam Core

PVC/Polypropylene Foam Core

Aluminum/Phenolic Foam Core

Aluminum/Polyurethane Foam Core

Aluminum/PVC Foam Core

Polyurethane/Polypropylene Foam Core

SiC/Polybenzimidazole Foam Core

SiC/Phenolic Foam Core

SiC/Polyurethane Foam Core

List of Some Other Foam Materials that May be Combined:

Open Cell:

PVC

PU

Silicone

Aluminum

Carbon

SiC

Nickel

Copper

Zirconia

Closed Cell:

Phenolic

ABS

Polyethylene

Polypropylene

PMMA

PVC

Polycarbonate

Epoxy

Polyurethane

Polybenzimidazole

Polyethersulfone

Polymethacrylimid

Industry

Hybrid foam sandwich cores may find niches in the automotive, aerospace, and packaging industries.

The number of pores per inch and density of the foam may also be modified. This may introduce even further diversity into the foam and its properties.

### EXAMPLE 3

### Biological

Another foam uses a primary foam material of vitreous carbon foam or other biologically neutral foam, filled with a biodegradable polymer foam material. The primary/matrix foam may permanently become part of the tissue, to allow growth within the foam. Secondary polymer foam which is inside intentionally degrades slowly, and is replaced by tissue within the larger matrix structure. The porosity of the inner biodegradable polymer would provide increased surface area and accelerate tissue growth rate. The shape and/or other properties of the primary foam could be selected to best suit the surrounding tissue, for example.

Possible applications of these related materials in tissue repair may incorporate a primary foam that is seated with long-term therapy agents. The filler foam is slowly biodegradable and may be replaced with new bone by foam growth factors incorporation within the structure.

Although only a few embodiments have been disclosed in detail above, other modifications are possible. All such modifications are intended to be encompassed within the following claims.

What is claimed is:

1. A foam composite material, comprising:
a primary foam material having a material structure with voids between sections of the primary foam materials; and
a secondary foam material, of a different material than the primary foam material, and having sections located within the voids of the primary foam material.

2. A foam material as in claim 1, wherein said primary foam material is an open cell foam.

3. A foam material as in claim 2, wherein said secondary foam material is an open cell foam.

4. A foam material as in claim 2, wherein said secondary foam material is a closed cell foam.

5. A foam that as in claim 1, wherein each of said primary and secondary foams are one of polymer foams or metallic foams.

6. A foam material as in claim 1, wherein said primary foam is a cured open cell foam.

7. A foam material that as in claim 1, wherein said hybrid foam has characteristics that optimize the foam for absorbing sound.

8. A foam material as in claim 7, wherein said characteristics include primary and secondary materials having different Young's moduli.

9. A foam material as in claim 8, wherein said material has a repetition of mismatches of Young's modulus across its thickness.

10. A foam material as in claim 1, wherein one of said materials is polyurethane foam, and the other of said materials is phenolic foam.

11. A foam material as in claim 1, wherein one of said foams is a foam which has low strain, and another of said foams is a foam which has improved flammability characteristic s.

12. A foam material as in claim 11, wherein said first foam is polyurethane which has improved peel stress characteristics, and said second foam is phenolic foam which has improved flammability characteristics.

13. A foam material as in claim 10 further comprising hardened materials on opposite sides of the foam.

14. A foam material as in claim 1, wherein said primary foam material is a biologically neutral foam, and said secondary foam material is a biodegradable polymer foam.

15. A foam material as in claim 14, wherein said first foam is a primary long-term therapy agent, and said second foam is one which is optimized for replacement with bone parts.

16. A method of forming a mechanically combined foam material, comprising
obtaining a cured open cell foam; and
soaking the open cell foam within an uncured foam resin, to allow the secondary foam resin to penetrate into open cells of the primary foam.

17. A method as in claim 16, further comprising compressing the primary foam while soaking in the secondary foam.

18. A method as in claim 17, wherein said foam is a polymer foam.

19. A method as in claim 16, further comprising using said foam with a first material which becomes part of living tissue, and with a second material which degrades slowly and is replaced by living tissue.

20. A method as in claim 14, wherein said first material is a biologically neutral material and said second material is a biodegradable polymer material.

21. A method, comprising:
obtaining a first foam in a specified shape; and
soaking said first foam into a resin bath having a second foam, to mechanically mix said second foam with said first foam to form a mechanically mixed foam.

22. A method as in claim 21, wherein said predefined shape comprises a shape of a final foam.

23. A method as in claim 21, wherein said predefined shape includes chunks of specified sizes.

24. A method as in claim 23, further comprising forming a final foam in the desired shape by curing the impregnated foam.

25. A method, comprising:
soaking the primary foam material with an open cell structure into voids between sections into a resin including a secondary foam material; and
allowing said primary foam material to absorb parts of said secondary foam material.

26. A method as in claim 25, further comprising molding the primary foam material into a desired shape.

27. A method as in claim 25, further comprising using a plurality of separated sections of primary foam material.
